(19) United States
(12) Patent Application Publication
(10) Pub. No.: US 2017/0347059 A1
(43) Pub. Date: Nov. 30, 2017

(54) ELECTRONIC APPARATUS AND CONTROLLING METHOD THEREOF

(71) Applicant: SAMSUNG ELECTRONICS CO., LTD., Suwon-si (KR)

(72) Inventor: Dale YIM, Suwon-si (KR)

(73) Assignee: SAMSUNG ELECTRONICS CO., LTD., Suwon-si (KR)

(21) Appl. No.: 15/415,409

(22) Filed: Jan. 25, 2017

(30) Foreign Application Priority Data
May 27, 2016 (KR) 10-2016-0065319

(51) Int. Cl. H04N 7/01

(52) U.S. Cl. CPC H04N 7/014; H04N 7/0147

(57) ABSTRACT

An electronic device is provided. The electronic apparatus includes a preprocessor configured to determine a repeated image frame in an image frame and perform an inverse conversion image processing only on one image frame in each image frame set consisting of the repeated image frame, and a frame rate converter configured to perform a frame rate conversion by using the image frame output from the preprocessor.

### CROSS-REFERENCE TO RELATED APPLICATION

This application claims priority from Korean Patent Application No. 10-2016-0065319, filed on May 27, 2016 in the Korean Intellectual Property Office, the disclosure of which is incorporated herein by reference in its entirety.

### BACKGROUND

### Field

Apparatuses and methods consistent with exemplary embodiments relate to an electronic apparatus and a controlling method thereof, and more particularly, to an electronic apparatus capable of converting a frame rate for an image frame and a controlling method thereof.

### Description of the Related Art

A frame rate conversion means an image processing scheme of calculating a motion vector between image frames and interpolating between image frames according to the motion vector to generate a new image frame. For example, an image having a frame rate of 60 Hz may be interpolated at double to be changed to 120 Hz.

As such, the frame rate conversion is performed to prevent a drag phenomenon of a liquid crystal display (LCD). That is, if the image frame is displayed by 60 frames per one second, the image frame looks like being dragged due to an afterimage remaining in a previous image frame, and therefore the image frame is displayed by 120 frames per one second by the frame rate conversion to alleviate the drag phenomenon.

However, when the frame rate conversion is performed, the processing needs to be repeatedly performed as many as the number of image frames increased due to the interpolation, and therefore a power use of an IC is increased as many as the number of image frames. As a result, a method for saving power is required.

### SUMMARY

Exemplary embodiments address at least the above problems and/or disadvantages and other disadvantages not described above. Also, the exemplary embodiments are not required to overcome the disadvantages described above, and may not overcome any of the problems described above.

One or more exemplary embodiments provide an electronic apparatus capable of performing an inverse conversion image processing on a specific image frame in an image frame before a frame rate conversion and a controlling method thereof.

According to an aspect of an exemplary embodiment, there is provided an electronic apparatus including: a preprocessor configured to determine a repeated image frame in an image frame and perform an inverse conversion image processing only on one image frame in each image frame set consisting of the repeated image frame; and a frame rate converter configured to perform a frame rate conversion by using the image frame output from the preprocessor.

The preprocessor may determine the repeated image frame in the image frame according to a film detection.

The preprocessor may calculate an error sum (Errsum) value for the image frame and control the inverse conversion image processing on the image frame according to the error sum value.

The preprocessor may perform the inverse conversion image processing on an overall area or some area of the image frame in response to determining that the error sum value for the overall area or some area of the image frame is smaller than a preset threshold value.

The preprocessor may bypass the inverse conversion image processing or adjust a gain to a preset value at the time of the inverse conversion image processing to perform the inverse conversion image processing on the overall area or some area of the image frame, in response to determining that the error sum value for the overall area or some area of the image frame is equal to or larger than the preset threshold value.

The preprocessor may adjust a gain to a preset value at the time of the inverse conversion image processing to perform the inverse conversion image processing on the overall area or some area of the image frame, in response to determining that the error sum value for the overall area or some area of the image frame is equal to or larger than the preset threshold value.

The frame rate converter may repeat the image frame to perform the frame rate conversion, in response to determining that the error sum value for the overall area of the image frame is equal to or larger than the preset threshold value.

The frame rate converter may differentially perform frame rate conversion processing on a plurality of areas configuring the image frame according to the error sum value for some area of the image frame.

According to another aspect of an exemplary embodiment, there is provided a controlling method of an electronic apparatus including: determining a repeated image frame in an image frame and performing an inverse conversion image processing only on one image frame in each image frame set consisting of the repeated image frame; and performing a frame rate conversion by using the image frame on which the inverse conversion image processing is performed.

In the performing of the inverse conversion image processing, the repeated image frame in the image frame may be determined according to a film detection.

In the performing of the inverse conversion image processing, an error sum (Errsum) value for the image frame may be calculated and the inverse conversion image processing on the image frame may be controlled according to the error sum value.

In the performing of the inverse conversion image processing, the inverse conversion image processing may be performed on an overall area or some area of the image frame in response to determining that the error sum value for the overall area or some area of the image frame is smaller than a preset threshold value.

In the performing of the inverse conversion image processing, the inverse conversion image processing may be bypassed in response to determining that the error sum value for the overall area or some area of the image frame is equal to or larger than the preset threshold value.

In the performing of the inverse conversion image processing, the inverse conversion image processing may be adjusted to a preset value at the time of the inverse conversion image processing to perform the inverse conversion image processing on the overall area or some area of the image frame in response to determining that the error sum value for the overall area or some area of the image frame is equal to or larger than the preset threshold value.

In the performing of the inverse conversion image processing, the image frame may be repeated to perform the frame rate conversion, in response to determining that the error sum value for the overall area of the image frame is equal to or larger than the preset threshold value.

In the performing of the inverse conversion image processing, frame rate conversion processing may be differentially performed on a plurality of areas configuring the image frame according to the error sum value for some area of the image frame.

### BRIEF DESCRIPTION OF THE DRAWINGS

The above and/or other aspects will be more apparent by describing in detail exemplary embodiments with reference to the accompanying drawings, in which:

FIG. 1 is a block diagram for describing a configuration of an electronic apparatus according to an exemplary embodiment;

FIGS. 2 to 4 are diagrams for describing an inverse conversion filter according to an exemplary embodiment;

FIGS. 5 and 6 are diagrams for describing a method for performing motion effect processing on an image frame according to an exemplary embodiment; and

FIG. 7 is a flow chart for describing a controlling method of an electronic apparatus according to an exemplary embodiment.

### DETAILED DESCRIPTION OF THE EXEMPLARY EMBODIMENTS

The exemplary embodiments may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the inventive concept. Also, well-known functions or constructions are not described in detail since they would obscure the disclosure with unnecessary detail.

The terms “first”, “second”, etc. may be used to describe various components, but the components are not limited by the terms. The terms are only used to distinguish one component from the others.

The terms used in the specification are only used to describe the exemplary embodiments, but are not intended to limit the scope of the inventive concept. The singular expression also includes the plural meaning as long as it does not differently mean in the context. In the specification, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Hereinafter, exemplary embodiments will be described in detail with reference to the accompanying drawings.

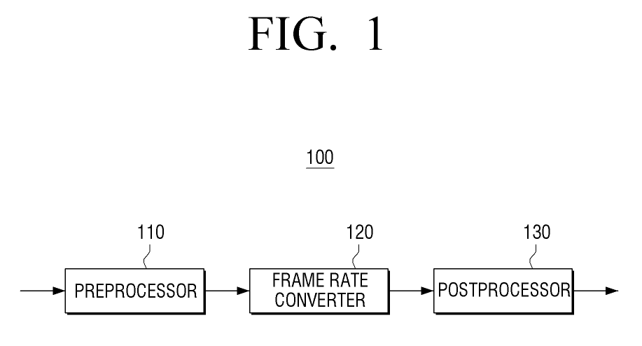

FIG. 1 is a block diagram for describing a configuration of an electronic apparatus according to an exemplary embodiment.

Referring to FIG. 1, the electronic apparatus 100 may include a preprocessor 110, a frame rate converter 120, and a postprocessor 130.

The preprocessor 110 performs preprocessing on an image frame before a frame rate conversion. For example, knowing that the image frame is repeated when the frame rate conversion is performed, the preprocessor 110 determines the repeated image frames among the image frames in that it can more effectively search for a motion vector.

In detail, the preprocessor 110 may determine the repeated image frames in the image frame on the basis of film detection.

For example, in the film detection, if the input image frame corresponds to 32 films, the input image frame is configured so that the same image frame is repeated by 3 and 2. That is, if the image frame is A, B, C, D and corresponds to 32 films, the image frames A, B, C, and D may be repeatedly input by 3, 2, 3, and 2 (e.g., A, A, A, B, B, C, C, C, D, D).

As a result, the preprocessor 110 may perform the film detection on the input image frame to determine the repeated image frames among the input image frames.

The preprocessor 110 may perform additional operations required for the frame rate conversion, for example, determining the repeat frame.

In detail, the preprocessor 110 may perform an inverse conversion image processing on the image frame.

Here, the inverse conversion image processing may be an image quality processing that performs inverse conversion filtering on an input image frame having a low resolution to recover an original image frame having a high resolution and may be performed by an inverse conversion filter such as a low pass filter and a high pass filter.

The preprocessor 110 may not perform the inverse conversion image processing on all the input image frames but perform the inverse conversion image processing only on some of the input image frames.

In detail, the preprocessor 110 may refer to a result of film detection to determine the repeated image frames among the input image frames and may perform the inverse conversion image processing only on one image frame in each of the image frame sets consisting of the repeated image frames.

Here, the image frame set means a set of the image frames consisting of the same image frames repeated.

That is, the preprocessor 110 performs the inverse conversion image processing only on one of the repeated image frames and outputs the processed image frame to the frame rate converter 120. The preprocessor 110 may output the rest image frames to the frame rate converter 120 or remove the rest image frames without performing (that is, bypass) the inverse conversion image processing on the rest image frames.

As described above, the image frames A, B, C, and D are repeated in 32 film patterns and if the image frames are input as A, A, A, B, B, C, C, C, D, D, each of the image frame sets becomes (A, A, A), (B, B), (C, C, C), (D, D).

In this case, the preprocessor 110 selects only one image frame in each of the image frame sets (A, A, A), (B, B), (C, C, C), (D, D) and performs the inverse conversion image processing only on the selected image frames A, B, C, D and does not perform the inverse conversion image processing on the rest image frames A, A, B, C, C, D.

As such, according to the exemplary embodiment, it is possible to save power consumed at the time of the image processing in that the inverse conversion image processing is performed on the image frame in the preprocessing operation before the frame rate conversion, not in the post-processing operation after the frame rate conversion.

For example, the case in which the image frame of 32 film patterns is input by 60 frames per one second and 480 image frames are output by the frame rate conversion is assumed.

In this case, if the inverse conversion image processing is performed in the post-processing operation, the inverse conversion image processing has to be performed on the 480 image frames. However, according to the exemplary embodiment, the inverse conversion image processing is performed only on one of the repeated image frames in the preprocessing operation and the frame rate conversion is performed using them. Therefore, in the preprocessing operation, the inverse conversion image processing is performed only on 24 (=60×2/5) image frames, and therefore the inverse conversion image processing is performed on a smaller number of image frames than when the inverse conversion image processing is performed in the post-processing operation, thereby promoting power saving.

Meanwhile, in the case of the specific image frame depending on the characteristics of the image frame, if the inverse conversion image processing is not performed on the corresponding image frame, it is difficult to obtain better image quality. For example, that is exactly the case in which sharpness of noise of the image frame after the inverse conversion image processing is increased.

Therefore, according to the exemplary embodiment, in consideration of the characteristics of the image frame, the inverse conversion image processing may be selectively performed or a gain may be adjusted to perform the inverse conversion image processing on the image frame.

For this purpose, the preprocessor 110 calculates an error sum (Errsum) value for the image frame.

In detail, the preprocessor 110 may calculate an error sum value for the selected image frame in each of the image frame sets.

Here, the error sum value may include an error sum value Errsum_Frame for the overall area of the image frame and an error sum value Errsum_Area for some area of the image frame.

In detail, the preprocessor 110 may calculate an error value ε defined by a blur model as shown in the following Equation 1. In the Equation 1, the error value ε is the error value for each pixel of the image frame and may be considered as a middle frequency or a high frequency component including a specific frequency component.

y=H*x+ε [Equation 1]

In the Equation 1, x represents a pixel value (that is, a pixel value of the image frame output from the inverse conversion filter) of the image frame before the blurring, H is a forward filter having a size of N×N performing the blurring by reducing a focus, and y represents the pixel value (that is, pixel value of the image frame input to the inverse conversion filter) of the image frame after the blurring.

In such a blur model, the preprocessor 110 may calculate the error value ε based on the following Equation 2.

ε=H^{T}y−H²xⁿ [Equation 2]

In the Equation 2, H^{T} represents a transpose matrix for H and H² represents a square matrix for H.

Further, n represents an iteration frequency through a feedback loop at the time of the inverse conversion filtering and xⁿ, xⁿ⁺¹ satisfy a relation of the following Equation 3. In the Equation 3, b is a preset value.

n⁺¹=xⁿ+bε [Equation 3]

That is, the preprocessor 110 may calculate the error value ε by subtracting a value obtained by filtering the pixel value of the image frame input to the inverse conversion filter using the H^{T} from a value obtained by filtering the pixel value of the image frame output from the inverse conversion filter using the H² as the Equation 2. In this case, as shown in the Equation 3, the pixel value of the image frame output from the inverse conversion filter may be updated on the basis of the error value c.

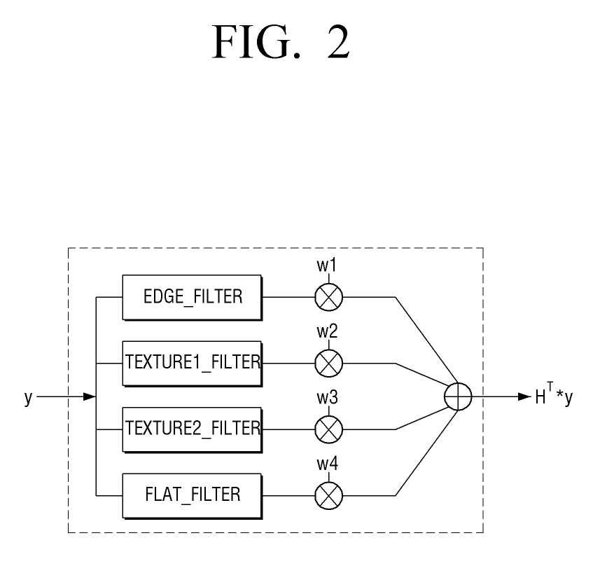

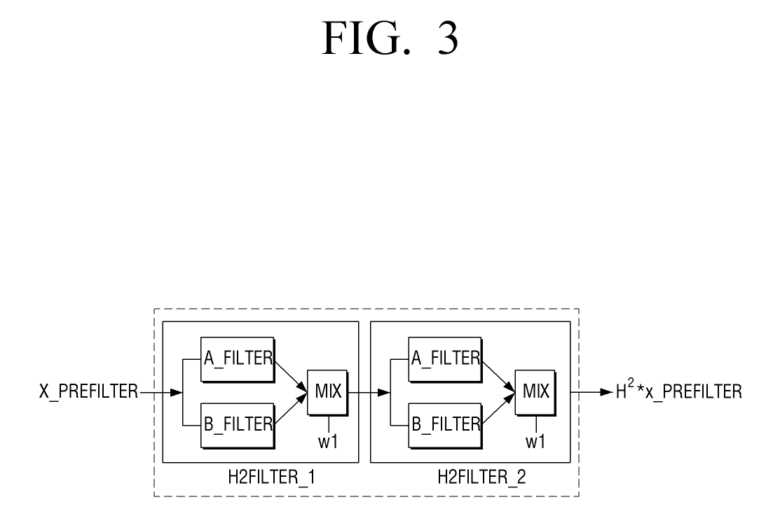

Meanwhile, in the Equation 2, the H^{T} may be implemented by an H1 filter as illustrated in FIG. 2, the H² may be represented by an H2 filter as illustrated in FIG. 3. Further, xⁿ is x_prefilter in which x is pre-filtered. Therefore, the Equation 2 may be represented by ε=H1_Filter*y−H2_Filter*x_prefilter.

Referring to FIG. 2, the H1 filter may include an edge filter (Edge_Filter) for filtering an edge area of the image frame, a texture filter (Texture1_Filter, Texture2_Filter) for filtering a texture area of the image frame, and a flat filter (Flat_Filter) for filtering a flat area of the image frame, in which outputs of each filter are given weights w1, w2, w3, and w4 and then may be summed and output. Further, since each filter filters the edge area, the texture area, and the flat area of the image frame, each filter may be implemented by a Gaussian filter having a central frequency, a bandwidth, or the like which is suitable for the filtering of each area in connection with the improvement in sharpness.

Referring to FIG. 3, the H2 filter may include an A filter (A_Filter) and a B filter (B_Filter) that are implemented by the Gaussian filter having different central frequencies and bandwidths, or the like. Outputs of a first A filter and B filter are mixed while being given a weight w1 and then are input to a second A filter and B filter. Outputs of the second A filter and B filter may be mixed and output while being given the weight w1.

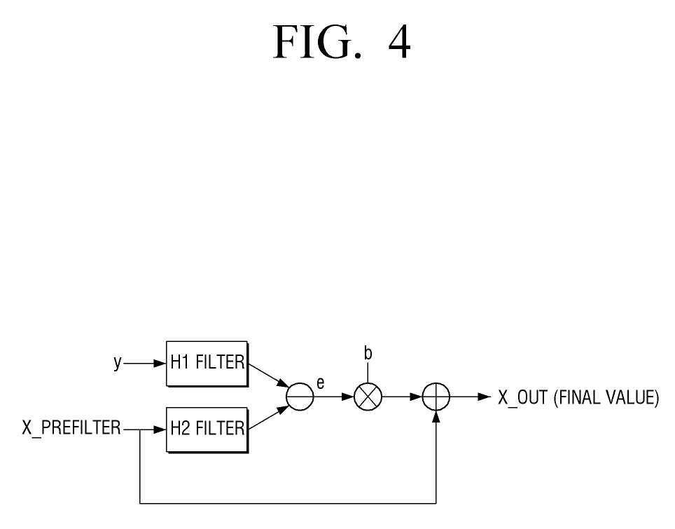

Therefore, the inverse conversion filter may be represented as illustrated in FIG. 4. In FIG. 4, ε=H1_Filter*y−H2_Filter*x_prefilter, x_out=x_prefilter+b*ε and a final output of the inverse conversion filter is as x_out (x_out (Final Value)).

The above Equation 2 may calculate and derive the error value ε that may minimize an x value in the blur model on the basis of a minimum means square error (MMSE). The detailed method thereof is shown in the following Equations 4 to 6.

$$\begin{matrix}y = Hx + a & [ Equation 4 ] \\ {a}^{2} = {( y - Hx )}^{2} & [ Equation 5 ] \\ \frac{d}{dx} {a}^{2} = ( - {H}^{T} ) * 2 ( y - H * x ) = - 2 ( {H}^{T} * y - {H}^{2} * x ) & [ Equation 6 ]\end{matrix}$$

In detail, the Equation 5 is derived by the Equation 4 and the partial differential of Equation 5 with respect to x is performed. In the Equation 5, a²=ε and the ε value that may minimize the x value is calculated on the basis of the above process, such that the ε value that may minimize x depending on the Equation 6 is as ε=H^{T}*y−H²*x.

The preprocessor 110 may use the calculated error value to calculate the error sum value for the overall area or some area of the image frame.

In detail, the preprocessor 110 may sum the error values for all the pixels of the image frame to calculate the error sum value for the overall area of the image frame and may sum the error values for the pixels of the specific area of the image frame to calculate the error sum value for the corresponding area.

The preprocessor 110 may control the inverse conversion image processing on the image frame on the basis of the error sum value.

In detail, the preprocessor 110 may calculate the error sum value for the selected image frame in each of the image frame sets, may not perform the inverse conversion image processing on the selected image frame on the basis of the error sum value, or may perform the inverse conversion image processing on the selected image frame by adjusting the gain.

The preprocessor 110 may perform the inverse conversion image processing on the overall area or some area of the image frame if the error sum value for the overall area or some area of the image frame is smaller than a preset threshold value.

That is, if the error sum value for the overall area or some area of the image frame is smaller than the preset threshold value, the preprocessor 110 may perform the inverse conversion image processing on the selected image frame in each of the image frame sets and output the image frame on which the inverse conversion image processing is performed to the frame rate converter 120.

However, if the error sum value for the overall area or some area of the image frame is equal to or larger than the preset threshold value, the preprocessor 110 may not perform (that is, bypass) the inverse conversion image processing or may adjust the gain to the preset threshold value at the time of the inverse conversion image processing to perform the inverse conversion image processing on the overall area or some area of the image frame.

In detail, since the error sum value may be considered as a level for noise present in the image frame, the preprocessor 110 may perform the inverse conversion image processing on the image frame if the error sum value is smaller than the preset threshold value, but may not perform the inverse conversion image processing on the image frame if the error sum value is equal to or larger than the preset threshold value and output the image frame to the frame rate converter 120 or may adjust the gain, perform the inverse conversion image processing on the image frame, and then output the image frame on which the inverse conversion image processing is performed to the frame rate converter 120.

Here, in the inverse conversion image processing, the input image frame is filtered using the inverse conversion filter and the image frame on which the inverse conversion filtering is performed is mixed with the image frame (that is, input image frame) on which the inverse conversion filtering is not performed to output the final image frame. Here, adjusting the gain means adjusting the weight that is applied to the mixed image frames.

In detail, if the error sum value is equal to or larger than the preset threshold value, the preprocessor 110 increases the weight applied to the input image frame to be larger by the preset value than the weight set as default and applies the increased weight to the corresponding image frame and decreases the weight applied to the image frame on which the inverse conversion filtering is performed to be smaller by the preset value than the weight set as default and applies the decreased weight to the corresponding image frame and then may mix the image frames with each other.

That is, in the case of the image frame in which the error sum value is equal to or larger than the preset threshold value, the inverse conversion filtering is performed, and thus the sharpness of the noise present in the corresponding image frame may be increased. Therefore, according to the exemplary embodiment, to reduce artifact due to the noise, when the image frames are mixed, a relatively larger weight is given to the image frame on which the inverse conversion filtering is not performed than the image frame on which the inverse conversion filtering is performed.

As such, according to the exemplary embodiment, the inverse conversion image processing is performed only on the selected image frame in each of the image frame sets consisting of the repeated image frames. In addition, because the inverse conversion image processing is selectively performed on the corresponding image frame depending on the error sum value, the number of image frames on which the inverse conversion image processing is performed is reduced, thereby promoting the power saving.

The frame rate converter 120 uses the image frame output from the preprocessor 110 to perform the frame rate conversion.

In detail, the frame rate converter 120 may determine the motion vector on the basis of motion estimation (ME) for an object present in the selected image frame using the selected image frames in each of the image frame sets and perform motion compensation (MC) for the object using the motion vector, thereby generating a new image frame between the selected image frames. Here, generating the interpolation frame using the motion frame is already known, and therefore the detailed description thereof will be omitted.

The frame rate converter 120 may interpolate the image frame to change the frame rate of the image frame.

For example, if the input image frame is 60 Hz, the frame rate converter 120 may interpolate the image frame on the basis of the frame rate conversion to output the image frames of 120 Hz, 240 Hz, and 480 Hz.

If a command for the motion effect processing is input, the frame rate converter 120 may perform the motion effect processing on the image frame generated for the frame rate conversion.

In detail, the frame rate converter 120 may calculate the error sum value for the overall area of the selected image frame in each of the image frame sets and generate a new image frame between the image frames using the motion vector if the error sum value for the overall area of the calculated image frame is smaller than the preset threshold value.

However, if the calculated error sum value for the overall area of the selected image frame in each of the image frame sets is equal to or larger than the preset threshold value, the frame rate converter 120 may repeat the image frame to generate the new image frame between the image frames.

For example, if the calculated error value of the overall area for the image frame A is equal to or larger than the preset threshold value, the frame rate converter 120 may repeat the same image frame as the image frame A between the image frame A and the image frame B that is the subsequent image frame.

As such, according to the exemplary embodiment, to increase the blur effect, if the error sum value is equal to or larger than the preset threshold value, the new image frame is generated between the image frames by the repetition of the image frame, not by the motion vector.

Further, the frame rate converter 120 may differentially perform the frame rate conversion on the plurality of areas configuring the image frame on the basis of the error sum value for some area of the image frame. That is, the frame rate converter 120 may perform the differentiated motion effect processing on the plurality of areas configuring the image frame.

In detail, the frame rate converter 120 divides the selected image frame in each of the image frame sets into the plurality of areas and sums the error values for the pixels present in each area to calculate the error sum value for each area.

Further, the frame rate converter 120 generates a new image frame using the motion vector for the area in which the calculated error sum value is smaller than the preset threshold value but may repeat the corresponding area for the area in which the calculated error sum value is equal to or larger than the preset threshold value to generate a new image frame or may reduce the size of the motion vector of the corresponding area by the preset ratio and then generate a new image frame using the same.

If new image frame is generated, the motion effect may be increased in the image frame, and the area in which the error sum value is equal to or larger than the preset threshold value is more blurred than other areas.

Meanwhile, the area in which the motion effect is increased may also be selected according to a user command. For example, if the user command for increasing the motion effect is input, the electronic device 100 may display the screen divided into the plurality of areas. If a specific area is selected, the frame rate converter 120 may repeat the corresponding area in the previous image frame for the area selected according to the user command or generate a new image frame using the reduced motion vector.

Further, the frame rate converter 120 may perform the motion effect processing on the specific area of the image frame.

For example, the frame rate converter 120 may use the motion vector to generate a new image frame in the area in which the motion is relatively small in the image frame but perform the motion effect processing on the area in which the motion is relatively larger, for example, a panning. Here, the panning means that the motion of the pixel is to be large by each image frame.

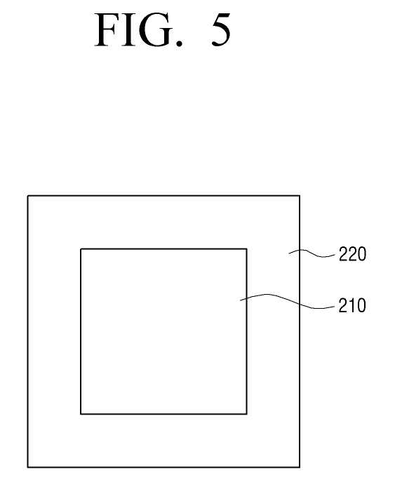

As another example, the frame rate converter 120 may divide the image frame into two areas as illustrated in FIG. 5. The frame rate converter 120 may use the motion vector to generate a new image frame for a central region 210 of the image frame, but repeat the corresponding area in the previous image frame for an adjacent region 220 adjacent to the central area 210 to generate a new image frame.

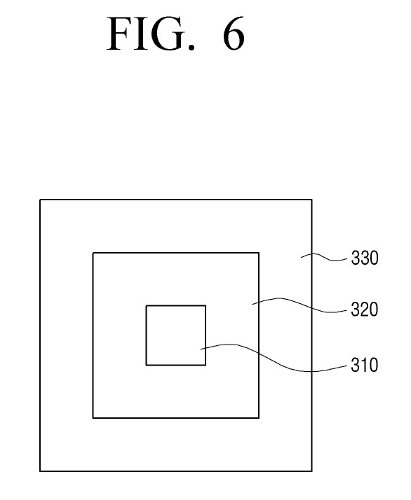

As another example, the frame rate converter 120 may divide the image frame into three areas as illustrated in FIG. 6. The frame rate converter 120 may use the motion vector to generate a new image generate for the central area 310 of the image frame, but perform the motion effect processing on a first adjacent area 320 adjacent to the central area 210 and a second adjacent area 330 adjacent to the first adjacent area 320.

In detail, the frame rate converter 120 may use the motion vector having a reduced size for the second adjacent area 330 and repeat the corresponding area in the previous image frame for the first adjacent area 320 to generate a new image frame.

As such, according to the exemplary embodiment, an object that a user carefully looks at is located at the central portion of the image frame and is located at a background as being farther away from the central portion, and therefore is more blurred outwardly from the center of the image frame, thereby reducing power consumption due to the motion estimation, or the like while improving the motion effect for the object.

The exemplary embodiment described-above using the error sum value is only an example, and the frame rate converter 120 may use other values to perform the motion effect processing.

For example, the frame rate converter 120 may use an average value of the error sum value to perform the motion effect processing.

The frame rate converter 120 may divide the error sum values for the overall area of the image frame by the entire number of pixels to calculate the average value Errsum_Frame_Avg of the error sum value and perform the motion effect processing on the overall area of the image frame on the basis of the comparison result of the calculated average value with the preset threshold value. That is, the frame rate converter 120 may divide the error sum values for some area of the image frame by the number of pixels of the corresponding area to calculate the average value Errsum_Area_Avg of the error sum value and perform the motion effect processing on some area of the image frame on the basis of the comparison result of the calculated average value with the preset threshold value.

As another example, the frame rate converter 120 may calculate a sum absolute difference (SAD) value between the image frames and perform the motion effect processing on the image frame generated for the interpolation on the basis of the calculated SAD value.

In detail, if the calculated SAD value is smaller than the preset threshold value, the frame rate converter 120 may use the motion vector to generate a new image frame between the image frames and repeat the image frame if the calculated SAD value is equal to or larger than the preset threshold value to generate a new image frame between the image frames.

That is, since making the SAD value between the image frames large may mean that all the objects within the image frame move, the blurring processing does not have a big problem, such that the image frame may be repeated without performing the motion estimation to interpolate the image frame.

In the case of using the SAD value, the SAD value is calculated in the overall area of the image frame or the SAD value is calculated in some area of the image frame and thus the calculated SAD value is used to perform the motion effect processing on the overall area or some area of the image frame.

The postprocessor 130 performs the post-processing on the image frame output from the frame rate converter 120.

For example, the postprocessor 130 may perform processing such as a detail enhance, a color correction, a gamma correction, or the like on the image frame having the converted frame rate.

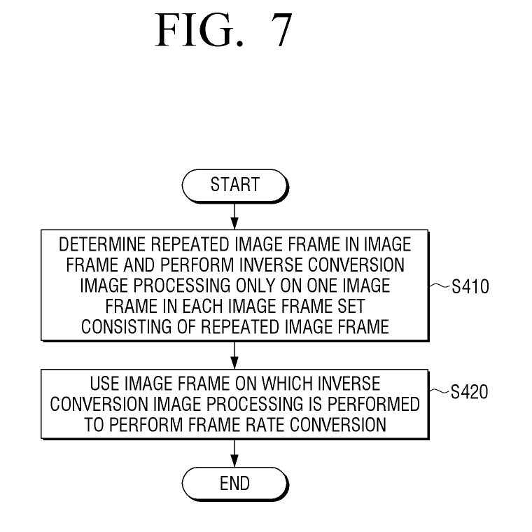

FIG. 7 is a flow chart for describing a controlling method of an electronic apparatus according to an exemplary embodiment.

First, the repeated image frame is determined in the image frame and the inverse conversion image processing is performed only on the image frame in each of the image frame sets consisting of the repeated image frames (operation S410).

Next, the frame rate conversion is performed using the image frame on which the inverse conversion image processing is performed (operation S420).

In the operation S410, the repeated image frames may be determined in the image frame on the basis of the film detection.

Further, the error sum (Errsum) value for the image frame may be calculated and the inverse conversion image processing on the image frame may be controlled on the basis of the error sum value.

In this case, the inverse conversion image processing may be performed on the overall area or some area of the image frame if the error sum value for the overall area or some area of the image frame is smaller than a preset threshold value. However, if the error sum value for the overall area or some area of the image frame is equal to or larger than the preset threshold value, the inverse conversion image processing may be bypassed or the gain is adjusted to the preset threshold value at the time of the inverse conversion image processing to perform the inverse conversion image processing on the overall area or some area of the image frame.

If the error sum value for the overall area of the image frame is equal to or larger than the preset threshold value, the image frame may be repeated to perform the frame rate conversion. Further, the frame rate conversion processing may be differentially performed on the plurality of areas configuring the image frame on the basis of the error sum value for some area of the image frame.

The controlling method of an electronic apparatus according to an exemplary embodiment can also be embodied as computer-readable codes on a non-transitory computer-readable recording medium. The non-transitory computer-readable recording medium includes any kind of recording device for storing data that can be read by a computer system.

The non-transitory computer readable medium is not a medium that stores data therein for a while, such as a register, a cache, a memory, or the like, but means a medium that semi-permanently stores data therein and is readable by a device. In detail, various applications and programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

At least one of the components, elements, modules or units represented by a block as illustrated in FIG. 1 may be embodied as various numbers of hardware, software and/or firmware structures that execute respective functions described above, according to an exemplary embodiment. For example, at least one of these components, elements, modules or units may use a direct circuit structure, such as a memory, a processor, a logic circuit, a look-up table, etc. that may execute the respective functions through controls of one or more microprocessors or other control apparatuses. Also, at least one of these components, elements, modules or units may be specifically embodied by a module, a program, or a part of code, which contains one or more executable instructions for performing specified logic functions, and executed by one or more microprocessors or other control apparatuses. Also, at least one of these components, elements, modules or units may further include or may be implemented by a processor such as a central processing unit (CPU) that performs the respective functions, a microprocessor, or the like. Two or more of these components, elements, modules or units may be combined into one single component, element, module or unit which performs all operations or functions of the combined two or more components, elements, modules or units. Also, at least part of functions of at least one of these components, elements, modules or units may be performed by another of these components, elements, modules or units. Further, although a bus is not illustrated in the above block diagrams, communication between the components, elements, modules or units may be performed through the bus. Functional aspects of the above exemplary embodiments may be implemented in algorithms that execute on one or more processors. Furthermore, the components, elements, modules or units represented by a block or processing steps may employ any number of related art techniques for electronics configuration, signal processing and/or control, data processing and the like.

Further, in the exemplary embodiment, the terms “module”, “unit”, “part”, etc., are terms naming components for performing at least one function or operation and these components may be implemented as hardware or software or implemented by a combination of hardware and software. Further, the plurality of “modules”, “units”, “parts”, etc., may be integrated as at least one module or chip to be implemented as at least one processor (not illustrated), except for the case in which each of the “modules”, “units”, “parts”, etc., needs to be implemented as individual specific hardware.

Although one or more exemplary embodiments have been illustrated and described, it will be appreciated by those skilled in the art that various changes in form and details may be made therein without departing from the spirit and scope of the exemplary embodiments as defined by the appended claims.

What is claimed is:

1. An electronic apparatus, comprising:
a preprocessor configured to determine a repeated image frame in an image frame and perform an inverse conversion image processing only on one image frame in each image frame set consisting of the repeated image frame; and
a frame rate converter configured to perform a frame rate conversion by using the image frame output from the preprocessor.

2. The electronic apparatus as claimed in claim 1, wherein the preprocessor is configured to determine the repeated image frame in the image frame according to a film detection.

3. The electronic apparatus as claimed in claim 1, wherein the preprocessor configured to calculate an error sum (Errsum) value for the image frame and control the inverse conversion image processing on the image frame according to the error sum value.

4. The electronic apparatus as claimed in claim 3, wherein the preprocessor is configured to perform the inverse conversion image processing on an overall area or some area of the image frame in response to determining that the error sum value for the overall area or some area of the image frame is smaller than a preset threshold value.

5. The electronic apparatus as claimed in claim 3, wherein the preprocessor is configured to bypass the inverse conversion image processing e, in response to determining that the error sum value for the overall area or some area of the image frame is equal to or larger than a preset threshold value.

6. The electronic apparatus as claimed in claim 3, wherein the preprocessor is configured to adjust a gain to a preset value at the time of the inverse conversion image processing to perform the inverse conversion image processing on the overall area or some area of the image frame, in response to determining that the error sum value for the overall area or some area of the image frame is equal to or larger than a preset threshold value.

7. The electronic apparatus as claimed in claim 3, wherein the frame rate converter is configured to repeat the image frame to perform the frame rate conversion, in response to determining that the error sum value for the overall area of the image frame is equal to or larger than the preset threshold value.

8. The electronic apparatus as claimed in claim 3, wherein the frame rate converter is configured to differentially perform frame rate conversion processing on a plurality of areas configuring the image frame according to the error sum value for some area of the image frame.

9. A controlling method of an electronic apparatus, comprising:
determining a repeated image frame in an image frame and performing an inverse conversion image processing only on one image frame in each image frame set consisting of the repeated image frame; and
performing a frame rate conversion by using the image frame on which the inverse conversion image processing is performed.

10. The controlling method as claimed in claim 9, wherein in the performing of the inverse conversion image processing, the repeated image frame in the image frame is determined according to a film detection.

11. The controlling method as claimed in claim 9, wherein in the performing of the inverse conversion image processing, an error sum (Errsum) value for the image frame is calculated and the inverse conversion image processing on the image frame is controlled according to the error sum value.

12. The controlling method as claimed in claim 11, wherein in the performing of the inverse conversion image processing, the inverse conversion image processing is performed on an overall area or some area of the image frame in response to determining that the error sum value for the overall area or some area of the image frame is smaller than a preset threshold value.

13. The controlling method as claimed in claim 11, wherein in the performing of the inverse conversion image processing, the inverse conversion image processing is bypassed, in response to determining that the error sum value for the overall area or some area of the image frame is equal to or larger than a preset threshold value.

14. The controlling method as claimed in claim 11, wherein in the performing of the inverse conversion image processing, the inverse conversion image processing is adjusted to a preset value at the time of the inverse conversion image processing to perform the inverse conversion image processing on the overall area or some area of the image frame, in response to determining that the error sum value for the overall area or some area of the image frame is equal to or larger than a preset threshold value.

15. The controlling method as claimed in claim 11, wherein in the performing of the inverse conversion image processing, the image frame is repeated to perform the frame rate conversion, in response to determining that the error sum value for the overall area of the image frame is equal to or larger than the preset threshold value.

16. The controlling method as claimed in claim 11, wherein in the performing of the inverse conversion image processing, frame rate conversion processing is differentially performed on a plurality of areas configuring the image frame according to the error sum value for some area of the image frame.
